(19) United States
(12) Patent Application Publication
(10) Pub. No.: US 2025/0374051 A1
(43) Pub. Date: Dec. 4, 2025

(54) METHOD AND APPARATUS FOR ACCESSING NETWORK

(71) Applicant: GUANGDONG OPPO MOBILE TELECOMMUNICATIONS CORP., LTD., Dongguan (CN)

(72) Inventors: Zhao RU, Dongguan (CN); Chaoming LUO, Dongguan (CN)

(73) Assignee: GUANGDONG OPPO MOBILE TELECOMMUNICATIONS CORP., LTD., Dongguan (CN)

(21) Appl. No.: 19/302,984

(22) Filed: Aug. 18, 2025

Related U.S. Application Data
(63) Continuation of application No. PCT/CN2023/093825, filed on May 12, 2023.

(51) Int. Cl. H04W 12/069; H04W 36/00; H04W 36/14

(52) U.S. Cl. CPC H04W 12/069; H04W 36/0038; H04W 36/14

(57) ABSTRACT

Provided are a method and apparatus for accessing a network. The method comprises: a first device receiving first information by means of a first communication network, wherein the first information is used for indicating a second communication network to the first device, and the first communication network supports a target authentication mode.

### CROSS-REFERENCE TO RELATED APPLICATIONS

This application is a continuation of International Application No. PCT/CN2023/093825, filed on May 12, 2023, the disclosure of which is hereby incorporated by reference in its entirety.

### TECHNICAL FIELD

This application relates to the field of communication technologies, and more specifically, to a method and apparatus for accessing a network.

### BACKGROUND

With continuous development of the technology, an increasing number of terminal devices are capable of connecting to a network. Therefore, how to improve user experience of a device connected to the network has become an urgent technical problem to be solved.

### SUMMARY

This application provides a method and apparatus for accessing a network. Various aspects of embodiments of this application are described below.

According to a first aspect, a method for accessing a network is provided. The method includes: receiving, by a first device, first information over a first communication network, where the first information is used to indicate a second communication network to the first device, and the first communication network supports a target authentication mode.

According to a second aspect, a method for accessing a network is provided. The method is applied to a second device including a first communication unit. The method includes: transmitting, by the first communication unit, first information over a first communication network, where the first information is used to indicate a second communication network to a first device, and the first communication network supports a target authentication mode.

According to a third aspect, a method for accessing a network is provided. The method includes: transmitting, by a third device, twelfth information, where the twelfth information is used to request enabling of the first communication network.

According to a fourth aspect, an apparatus for accessing a network is provided. The apparatus includes: a receiving unit, configured to receive first information over a first communication network, where the first information is used to indicate a second communication network to the apparatus, and the first communication network supports a target authentication mode.

According to a fifth aspect, an apparatus for accessing a network is provided. The apparatus includes a first communication unit, configured to transmit first information over a first communication network, where the first information is used to indicate a second communication network to a first device, and the first communication network supports a target authentication mode.

According to a sixth aspect, an apparatus for accessing a network is provided. The apparatus includes: a transmitting unit, configured to send twelfth information, where the twelfth information is used to request enabling of the first communication network.

According to a seventh aspect, an apparatus for accessing a network is provided. The apparatus includes a memory and a processor, where the memory is configured to store a program; and the processor is configured to invoke the program in the memory, to perform the method according to any one of the first aspect to the third aspect.

According to an eighth aspect, an apparatus for accessing a network is provided. The apparatus includes a processor configured to invoke the program from the memory, to perform the method according to any one of the first aspect to the third aspect.

According to a ninth aspect, a chip is provided. The chip includes a processor configured to invoke a program from a memory, to cause a device installed with the chip to perform the method according to any one of the first aspect to the third aspect.

According to a tenth aspect, a computer-readable storage medium is provided. The computer-readable storage medium stores a program, and the program causes a computer to perform the method according to any one of the first aspect to the third aspect.

According to an eleventh aspect, a computer program product is provided. The computer program product includes a program, and the program causes a computer to perform the method according to any one of the first aspect to the third aspect.

According to a twelfth aspect, a computer program is provided. The computer program causes a computer to perform the method according to any one of the first aspect to the third aspect.

In embodiments of this application, the first information is used to indicate the second communication network to the first device; and the first device receives the first information over the first communication network that supports the target authentication mode.

### BRIEF DESCRIPTION OF DRAWINGS

FIG. 1 is a diagram of an example of an application scenario according to an embodiment of this application.

FIG. 2 is a schematic flowchart of a method for accessing a network according to an embodiment of this application.

FIG. 3 is a schematic flowchart of a method for accessing a network according to another embodiment of this application.

FIG. 4 is a schematic flowchart of a method for accessing a network according to still another embodiment of this application.

FIG. 5 is a schematic structural diagram of an apparatus for accessing a network according to an embodiment of this application.

FIG. 6 is a schematic structural diagram of an apparatus for accessing a network according to another embodiment of this application.

FIG. 7 is a schematic structural diagram of an apparatus for accessing a network according to still another embodiment of this application.

FIG. 8 is a schematic structural diagram of an apparatus according to an embodiment of this application.

### DESCRIPTION OF EMBODIMENTS

The technical solutions in this application are described below with reference to the accompanying drawings.

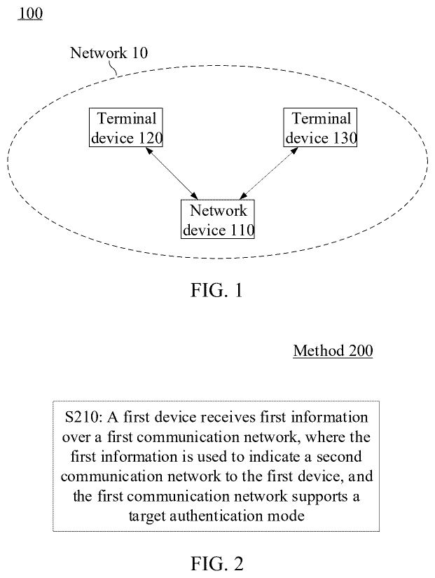

FIG. 1 shows an application scenario 100 according to an embodiment of this application. The application scenario 100 may include a network device 110, a terminal device 120, and a terminal device 130. The network device 110 can provide signal coverage for a specific geographic area, and can communicate with the terminal device 120 and the terminal device 130 within the coverage. The terminal device 120 and the terminal device 130 can access a network 10 via the network device 110.

FIG. 1 illustratively shows one network device and two terminal devices. Optionally, the application scenario 100 may include more or fewer network devices or terminal devices, which is not limited in embodiments of this application. It should be understood that embodiments of this application are not limited to the system architecture shown in FIG. 1. The technical solutions of embodiments of this application can be applied to various system architectures, which are not limited in embodiments of this application.

The network device 110 in embodiments of this application may also be referred to as an access point (AP) or the like. For example, the network device 110 may be a network controller, a router, a mobile phone, a tablet computer (Pad), a notebook computer, a palmtop computer, a wearable device, or the like.

The terminal device 120 and the terminal device 130 in embodiments of this application may also be referred to as node devices, nodes, access nodes, wireless nodes, transmission nodes, transmission reception nodes, user equipments (UEs), or the like. For example, the terminal device 120 and the terminal device 130 may be Internet-of-Things devices such as lighting, door locks, blinds, televisions, heating, ventilation and air conditioning systems, security sensors and controllers, and gateways.

In embodiments of this application, the terminal device 120 may be a device with administrator rights (namely, a managing device) in the network 10, and the terminal device 130 may be a managed device in the network 10. The terminal device may also be referred to as an IoT device or a device. The administrator rights allow the managed device to be configured. An administrator may also be an owner of the device. For example, the terminal device 120 may commission the terminal device 130 to access the network 10. The terminal device 120 may also be referred to as a managing device, a user device, a commissioner, or the like. For example, the terminal device 120 may be a mobile phone, a tablet computer, a notebook computer, a palmtop computer, a wearable device, or the like.

The network 10 in FIG. 1 may be Wi-Fi, Ethernet, or Thread. The network 10 may support multiple communication protocols (or multiple ecological platforms). For example, the network 10 may support the Matter protocol. The Matter protocol can be applied to Wi-Fi, Ethernet, Thread, or the like, and allows smart home devices in different communication networks to communicate with each other. The following uses the Matter protocol as an example to illustratively describe the communication protocols supported by the network 10.

In the Matter protocol, network interfaces can be managed through a network commissioning cluster. The network commissioning cluster is mainly used to associate a node with or manage one or more network interfaces of the node. These network interfaces can include the following types: Wi-Fi, Ethernet, and Thread.

The network commissioning cluster includes multiple commands and attributes, which are described in detail below.

### (1) ScanNetworks Command

This command can scan on an associated network interface of a cluster instance for either of: all available networks (non-directed scanning) or specific networks (directed scanning).

Scanning for available networks detects all networks of the type corresponding to the cluster server instance's associated network interface that are possible to join, such as all visible Wi-Fi access points for Wi-Fi cluster server instances, all Thread networks for Thread cluster server instances, within bounds of the maximum response size.

Scanning for a specific network (i.e., directed scanning) takes place if a network identifier (e.g., Wi-Fi service set identifier (SSID)) is provided in the command arguments. Directed scanning shall restrict the result set to the specified network only.

The arguments for the ScanNetworks command may be as follows:

| | Name | Type | Constraint | Quality | Default | Conformance |
|---|---|---|---|---|---|---|
| ID | (Name) | (Type) | (Constraint) | (Quality) | (Default) | (Conformance) |
| 0 | SSID | [octstr-def] | 1 to 32 | X | null | [WI] |
| 1 | Breadcrumb | uint64 | all | | | O |

SSID field: If the field is present (not null), this shall indicate a directed scan of the particular Wi-Fi SSID. If the field is absent (null), this shall indicate scanning of all basic service set identifiers (BSSID) in range.

Breadcrumb field: The Breadcrumb field, if present, shall be used to atomically set the Breadcrumb attribute in the General Commissioning cluster on success of the associated command. If the command fails, the Breadcrumb attribute in the General Commissioning cluster shall be left unchanged.

### (2) ScanNetworksResponse Command

This command shall contain the status of the last ScanNetworks command, and the associated scan results if the operation was successful.

| ID | Name | Type | Constraint | Default | Conformance |
|---|---|---|---|---|---|
| 0 | NetworkingStatus | NetworkCommissioningStatus | desc | | M |
| 1 | Debug Text | [string-def] | max 512 | | O |
| 2 | WiFiScanResults | [list-def][WiFiInterfaceScanResult] | desc | | WI |
| 3 | ThreadScanResults | [list-def][ThreadInterfaceScanResult] | desc | | TH |

The NetworkingStatus field may indicate the status of the last scan operation, the DebugText field may indicate error information, the WiFiScanResults field may indicate the Wi-Fi network scan results, and the ThreadScanResults field may indicate the Thread network scan results.

As can be seen from the above table, the WiFiScanResults field may include one or more WiFiInterfaceScanResult structures, and each WiFiInterfaceScanResult structure may represent a single Wi-Fi network scan result. The WiFiInterfaceScanResult structure may be as shown in the following table:

| | | | | | | |
|---|---|---|---|---|---|---|
| ID | Name | Type | Constraint | Quality | Access | Conformance |

| | | | | |
|---|---|---|---|---|
| 0 | Security | WiFiSecurity | all | WI |
| 1 | SSID | [octstr-def] | max 32 | WI |
| 2 | BSSID | [octstr-def] | 6 | WI |
| 3 | Channel | uint16 | all | WI |
| 4 | WiFiBand | WiFiBand | all | [WI] |
| 5 | RSSI | int8 | all | [WI] |

The Security field may indicate the Wi-Fi security types supported by the Wi-Fi network, the WiFiBand field may indicate the Wi-Fi frequency bands supported by different Wi-Fi frequency bands, and the RSSI field may indicate the signal strength in dBm of the associated scan result.

The Security field may be represented by the WiFiSecurity type. The WiFiSecurity type may be a bitmap encoded (such as map8) data type. The WiFiSecurity type may be as shown in the following table:

| Bit | Description |
|---|---|
| 0 | Unencrypted |
| 1 | WEP |
| 2 | WPA-PERSONAL |
| 3 | WPA2-PERSONAL |
| 4 | WPA3-PERSONAL |

The WiFiBand field may be represented by the WiFiBand type. The WiFiBand type may be an enumeration encoded (such as enum8) data type. The WiFiBand type may be as shown in the following table:

| Value | Description |
|---|---|
| 0 | 2.4 GHz-2.401 GHz to 2.495 GHz (802.11b/g/n/ax) |
| 1 | 3.65 GHz-3.655 GHz to 3.695 GHz (802.11y) |
| 2 | 5 GHz-5.150 GHz to 5.895 GHz (802.11a/n/ac/ax) |
| 3 | 6 GHz-5.925 GHz to 7.125 GHz (802.11ax/WiFi 6E) |
| 4 | 60 GHz-57.24 GHz to 70.20 GHz (802.11ad/ay) |

### (3) AddOrUpdateWiFiNetwork Command

This command shall be used to add or modify Wi-Fi network configurations.

The arguments for the AddOrUpdateWiFiNetwork command may be as follows:

| ID | Name | Type | Constraint | Default | Conformance |
|---|---|---|---|---|---|
| 0 | SSID | [octstr-def] | max 32 | | M |
| 1 | Credentials | [octstr-def] | max 64 | | M |
| 2 | Breadcrumb | uint64 | all | | O |

The SSID field may indicate the SSID to which to attempt connection, and the Credentials field may indicate the passphrase or PSK for the network (if any is needed). Breadcrumb field: The Breadcrumb field, if present, shall be used to atomically set the Breadcrumb attribute in the General Commissioning cluster on success of the associated command. If the command fails, the Breadcrumb attribute in the General Commissioning cluster shall be left unchanged.

### (4) NetworkConfigResponse Command

This response command relates to status information for some commands that require it as their response command.

The arguments for the NetworkConfigResponse command may be as follows:

| ID | Name | Type | Constraint | Default | Conformance |
|---|---|---|---|---|---|
| 0 | NetworkingStatus | NetworkCommissioningStatus | desc | | M |
| 1 | Debug Text | [string-def] | max 512 | | O |
| 2 | NetworkIndex | uint8 | 0 to | | O |
| | | | (MaxNetworks − 1) | | |

The NetworkingStatus field may indicate the status of the last operation that attempts to modify the Networks attribute configuration, the DebugText field may indicate error information, and the NetworkIndex field may indicate the index of the entry in the Networks attribute.

### (5) ConnectNetwork Command

This command shall attempt to connect to a network whose configuration was previously added by either the AddOrUpdateWiFiNetwork or AddOrUpdateThreadNetwork commands. The network is identified by its NetworkID.

The arguments for the ConnectNetwork command may be as follows:

| ID | Name | Type | Constraint | Conformance |
|---|---|---|---|---|
| 0 | NetworkID | [octstr-def] | 1 to 32 | M |
| 1 | Breadcrumb | uint64 | all | O |

The NetworkID field may indicate the NetworkID for the entry used to configure the connection, such as the SSID for Wi-Fi and the extended personal area network (XPAN) identifier (ID) for Thread. For the Breadcrumb field, refer to the description of the Breadcrumb field above, which will not be repeated here.

### (6) ConnectNetworkResponse Command

The arguments for the ConnectNetworkResponse command may be as follows:

| ID | Name | Type | Constraint | Quality | Conformance |
|---|---|---|---|---|---|
| 0 | NetworkingStatus | NetworkCommissioningStatus | all | | M |
| 1 | DebugText | [string-def] | | | O |
| 2 | Error Value | int32 | all | X | M |

The NetworkingStatus field may indicate the status of the last connection attempt, the DebugText field may indicate the error information, and the Error Value field may indicate the Error Value interpretation for Wi-Fi association errors: On any association failure during enabling of a network, the Error Value field shall be set to the status code value that was present in the last frame related to association.

### (7) ReorderNetwork Command

This command shall set the specific order of the network configuration selected by its NetworkID in the Networks attribute list to match the position given by NetworkIndex.

The arguments for the ReorderNetwork command may be as follows:

| ID | Name | Type | Constraint | Conformance |
|---|---|---|---|---|
| 0 | NetworkID | [octstr-def] | 1 to 32 | M |
| 1 | NetworkIndex | uint8 | desc | M |
| 2 | Breadcrumb | uint64 | all | O |

The NetworkID field may indicate the NetworkID for the entry to reorder, such as the SSID for Wi-Fi and the XPAN ID for Thread. The NetworkIndex field may indicate the 0-based index of the new desired position of the entry in the Networks attribute. For the Breadcrumb field, refer to the description of the Breadcrumb field above, which will not be repeated here.

### (8) Attributes

| ID | Name | Type | Constraint | Quality | Default | Access | Conformance |
|---|---|---|---|---|---|---|---|
| 0x0000 | MaxNetworks | uint8 | min 1 | F | | R A | M |
| 0x0001 | Networks | [list-def][NetworkInfo] | max | | empty | R A | M |
| | | | MaxNetworks | | | | |
| 0x0002 | ScanMaxTimeSeconds | uint8 | desc | F | | R V | WI \| TH |
| 0x0003 | ConnectMaxTimeSeconds | uint8 | desc | F | | R V | WI \| TH |
| 0x0004 | InterfaceEnabled | bool | | N | true | RW | M |
| | | | | | | VA | |
| 0x0005 | LastNetworkingStatus | NetworkCommissioningStatus | | X | null | R A | M |
| 0x0006 | LastNetworkID | [octstr-def] | 1 to 32 | X | null | R A | M |
| 0x0007 | LastConnectErrorValue | int32 | | X | null | R A | M |

### \textcircled{1} MaxNetworks Attribute

. This shall indicate the maximum number of network configuration entries that can be added, based on available device resources.
The length of the Networks attribute list shall be less than or equal to this value.

### \textcircled{2}Networks Attribute

This attribute shall indicate the network configurations that are usable on the network interface represented by this cluster server instance.

The order of configurations in the list reflects precedence. That is, any time the node attempts to connect to the network, it shall attempt to do so using the configurations in Networks attribute in the order as they appear in the list.

The order of list items shall only be modified by the AddOrUpdateThreadNetwork, AddOrUpdateWiFiNetwork, and ReorderNetwork commands. In other words, the list shall be stable over time, unless mutated externally.

Ethernet networks shall be automatically populated by the cluster server. Ethernet network commissioning cluster instances shall always have exactly one NetworkInfo structure instance in their Networks attribute. There shall be no way to add, update, or remove Ethernet network configurations to those cluster instances.

a. NetworkInfo Structure

The NetworkInfo structure describes an existing network configuration, as provided in the Networks attribute.

| | | | | | | |
|---|---|---|---|---|---|---|
| ID | Name | Type | Constraint | Quality | Access | Conformance |

| | | | | |
|---|---|---|---|---|
| 0 | NetworkID | [octstr-def] | 1 to 32 | M |
| 1 | Connected | bool | | M |

i. NetworkID Field

Every network is uniquely identified (for purposes of commissioning) by a NetworkID that maps to the following technology-specific properties:
WiFi: SSID
Thread: Extended PAN ID
Ethernet: Network interface instance name at operating system (or equivalent unique name)

The semantics of the NetworkID field therefore varies between network types accordingly. It contains SSID for Wi-Fi networks, extended PAN ID (XPAN ID) for Thread networks, and netif name for Ethernet networks.

XPAN ID is a big-endian 64-bit unsigned number, represented on the first 8 octets of the octet string.

ii. Connected Field

This field shall indicate the connected status of the associated network, where “connected” means currently linked to the network technology (e.g., Associated for a Wi-Fi network, media connected for an Ethernet network).

### \textcircled{3} ScanMax TimeSeconds Attribute

This attribute shall indicate the maximum duration taken (in seconds) by the network interface on this cluster server instance to provide scan results.

For usage, refer to the ScanNetworks command.

### \textcircled{4} ConnectMaxTimeSeconds Attribute

This attribute shall indicate the maximum duration taken (in seconds) by the network interface on this cluster server instance to report a successful or failed network connection indication. This maximum time shall account for all operations needed until a successful network connection is deemed to have occurred, including, for example, obtaining IP addresses, or the execution of necessary internal retries.

### \textcircled{5} InterfaceEnabled Attribute

This attribute shall indicate whether the associated network interface is enabled or not. By default all network interfaces should be enabled during initial commissioning (InterfaceEnabled set to true)

It is undefined what happens if InterfaceEnabled is written to false on the same interface as that which is used to write the value. In that case, it is possible that the administrator would have to await expiry of the fail-safe, and associated recovery of network configuration to prior safe values, before being able to communicate with the node again.

It may be possible to disable Ethernet interfaces but it is implementation-defined. If not supported, a write to this attribute with a value of false shall fail with a status of INVALID_ACTION. When disabled, an Ethernet interface would no longer employ media detection. That is, a simple unplug and replug of the cable shall not re-enable the interface.

On Ethernet-only nodes, there shall always be at least one of the network commissioning cluster instances with InterfaceEnabled set to true.

### \textcircled{6} LastNetworkingStatus Attribute

This attribute shall indicate the status of the last attempt either scan or connect to an operational network, using this interface, whether by invocation of the ConnectNetwork command or by autonomous connection after loss of connectivity or during initial establishment. If no such attempt was made, or no network configurations exist in the Networks attribute, then this attribute shall be set to null.

This attribute is present to assist with error recovery during network commissioning and to assist in non-concurrent networking commissioning flows.

### \textcircled{7} LastNetworkID Attribute

This attribute shall indicate the NetworkID used in the last attempt to connect to an operational network, using this interface, whether by invocation of the ConnectNetwork command or by autonomous connection after loss of connectivity or during initial establishment. If no such attempt was made, or no network configurations exist in the Networks attribute, then this attribute shall be set to null.

If a network configuration is removed from the Networks attribute using the RemoveNetwork command after a connection attempt, this field may indicate a NetworkID that is no longer configured on the node.

This attribute is present to assist with error recovery during network commissioning and to assist in non-concurrent networking commissioning flows.

\textcircled{8} LastConnectError Value Attribute

This attribute shall indicate the Error Value used in the last failed attempt to connect to an operational network, using this interface, whether by invocation of the ConnectNetwork command or by autonomous connection after loss of connectivity or during initial establishment. If no such attempt was made, or no network configurations exist in the Networks attribute, then this attribute shall be set to null.

If the last connection succeeded, as indicated by a value of Success in the LastNetworkingStatus attribute, then this field shall be set to null. This attribute is present to assist with error recovery during network commissioning and to assist in non-concurrent networking commissioning flows.

Among a plurality of terminal devices connected in the same local area network, only some of the terminal devices may support authentication using a target authentication mode. In this case, the local area network often does not support the target authentication mode. For example, devices such as televisions, lightings, door locks, air conditioners, refrigerators, and robotic vacuum cleaners are connected to someone's home Wi-Fi. Among them, the lightings and door locks do not support the Matter protocol (such as not supporting authentication through the node operational certificate (NOC) in a fabric), while the remaining devices support the Matter protocol. Since not all connected devices support the Matter protocol, the home Wi-Fi usually does not support the target authentication mode.

A terminal device connected to the local area network that does not support the target authentication mode may become offline (disconnected from the network). In this case, the terminal device can attempt to reconnect to the network. However, due to changes in network parameters or other reasons, the terminal device may fail to reconnect to the network. For example, when the terminal device is undergoing an over-the-air (OTA) update, network parameters may change, causing the terminal device to go offline. In this case, reconnecting to the network may also fail.

Therefore, for the terminal device connected to such a local area network that does not support the target authentication mode, how to improve a success rate of accessing the network by the terminal device has become an urgent technical problem to be solved.

To solve one or more of the above-described technical problems, this application provides a method and apparatus for accessing a network. With reference to FIG. 2 to FIG. 4, the following describes embodiments of this application in detail by using examples.

FIG. 2 is a schematic flowchart of a method for accessing a network according to an embodiment of this application. The method 200 shown in FIG. 2 may include step S210. Details are as follows.

S210: A first device receives first information over a first communication network.

The first device may be an Internet-of-Things (internet-of-things, IoT) device, for example, the terminal device in FIG. 1.

The first information may be used to indicate a second communication network to the first device. For example, the first information may be used to add the second communication network to the first device.

The first information may be transmitted by a second device. For example, the first device may receive, over the first communication network, the first information transmitted by the second device. The second device may be a network device, for example, the network device in FIG. 1. Optionally, the second device may include a first communication unit, and the first information may be transmitted by the first communication unit in the second device. For example, the first device may receive, over the first communication network, the first information transmitted by the first communication unit.

Optionally, the first communication unit may establish (or provide or produce) the first communication network.

Optionally, the first information may include an identifier of the second communication network. Optionally, the first information may further include a password or a shared key of the second communication network. Optionally, the first information may be carried in a modifying network (AddOrUpdate WiFiNetwork) command.

The communication network (such as the first communication network and/or the second communication network) may be a wired network or a wireless network. For example, the communication network may be Wi-Fi, Ethernet, or Thread.

The first communication network may support a target authentication mode. Optionally, supporting the target authentication mode may indicate supporting access to the communication network using the target authentication mode. The second communication network may not support the target authentication mode.

Optionally, the target authentication mode may indicate performing authentication by using a node operational certificate (NOC) in a fabric. For example, the target authentication mode may refer to Matter (Matter protocol) authentication; that is, authentication is performed by using a Matter NOC in the fabric as a credential.

Optionally, the fabric may refer to an ecological platform (also referred to as an ecological network), and different ecological platforms may correspond to different ecological manufacturers. For example, a fabric A may correspond to Google's ecology A, and a fabric B may correspond to Xiaomi's ecology B.

Optionally, before S210, the first device may be authenticated using the target authentication mode and access the first communication network.

In embodiments of this application, the first information is used to indicate the second communication network to the first device; and the first device receives the first information over the first communication network that supports the target authentication mode, so that the first device accesses the first communication network using the target authentication mode and then connects to the second communication network, thereby increasing a success rate of accessing the network by the terminal device.

For example, the second communication network in this application may not support the target authentication mode. If authentication is performed by using an authentication mode (such as authentication based on a Wi-Fi password) in the communication network, the authentication may fail. The first communication network may support the target authentication mode, and the node operational certificate (NOC) in the fabric is usually unchanged. Therefore, the first communication network may be first accessed through NOC authentication, and then the second communication network is connected based on the first information, thereby increasing the success rate of accessing the network by the terminal device.

In some embodiments, after S210, the first device may receive second information over the first communication network.

Optionally, the second information may be used to instruct the first device to join the second communication network. Optionally, the second information may be carried in a connect network (ConnectNetwork) command.

The second information may be transmitted by the second device. For example, the first device may receive, over the first communication network, the second information transmitted by the second device. Optionally, the second information may be transmitted by the first communication unit in the second device. For example, the first device may receive, over the first communication network, the second information transmitted by the first communication unit.

In some embodiments, the first device may receive third information over the first communication network.

Optionally, the third information may be used to instruct the first device to adjust precedence of the second communication network. For example, the third information may indicate the first device to adjust the precedence of the second communication network to the highest precedence. Optionally, the third information may be carried in a reorder network (ReorderNetwork) command.

The third information may be transmitted by the second device. For example, the first device may receive, over the first communication network, the third information transmitted by the second device. Optionally, the third information may be transmitted by the first communication unit in the second device. For example, the first device may receive, over the first communication network, the third information transmitted by the first communication unit.

In some embodiments, after S210, the first device may transmit fourth information over the first communication network.

Optionally, the fourth information may be used to request to hand over to the second communication network. Optionally, the fourth information may be carried in a fast basic service set transition (FT) request (Request) frame.

Optionally, the fourth information may include an identifier of the second communication network, an identifier of a shared key, and a first nonce. Optionally, the first nonce may be a nonce (such as SNonce) generated by the first device (such as the IoT device) in a Wi-Fi handshake procedure; or the first nonce may be a value obtained through processing (such as an encryption operation) a nonce generated by the first device in a Wi-Fi handshake procedure.

The fourth information may be received by the second device. For example, the first device may transmit the fourth information to the second device over the first communication network. Optionally, the fourth information may be received by the first communication unit in the second device. For example, the first device may transmit the fourth information to the first communication unit over the first communication network.

The second device may further include a second communication unit. Optionally, the second communication unit may establish (or provide or produce) the second communication network.

In some embodiments, after the first communication unit receives the fourth information over the first communication network, the first communication unit may transmit eighth information to the second communication unit.

Optionally, the eighth information may be used to indicate that the first device requests to hand over to the second communication network. Optionally, the eighth information may include a shared key, an identifier of the shared key, and a first nonce.

In some embodiments, after the first communication unit transmits the eighth information to the second communication unit, the second communication unit may transmit ninth information to the first communication unit.

Optionally, the ninth information may be used to indicate allowing the first device to hand over to the second communication network. Optionally, the ninth information may include a first nonce and/or a second nonce.

In some embodiments, after the first device transmits the fourth information over the first communication network, the first device may receive fifth information over the first communication network.

Optionally, the fifth information may be used to respond to the fourth information. Optionally, the fifth information may be carried in an FT response frame.

Optionally, the fifth information may be used to indicate allowing the first device to hand over to the second communication network. Optionally, the fifth information may include an identifier of the second communication network, an identifier of a shared key, a first nonce, and/or a second nonce. Optionally, the second nonce may be a nonce (such as ANonce) generated by the second device (such as the AP) in a Wi-Fi handshake procedure; or the second nonce may be a value obtained through processing (such as an encryption operation) a nonce generated by the second device in a Wi-Fi handshake procedure.

The fifth information may be transmitted by the second device. For example, the first device may receive, over the first communication network, the fifth information transmitted by the second device. Optionally, the fifth information may be transmitted by the first communication unit in the second device. For example, the first device may receive, over the first communication network, the fifth information transmitted by the first communication unit.

Further, the first device may be disconnect from the second device (corresponding to the first communication network).

In some embodiments, after the first device receives the fifth information over the first communication network, the first device may transmit sixth information.

Optionally, the sixth information may be used to request to hand over to the second communication network. Optionally, the sixth information may be carried in a reassociation request frame.

Optionally, the sixth information may include an identifier of a shared key, a first nonce, and/or a second nonce.

The sixth information may be received by the second device. For example, the first device may transmit the sixth information to the second device over the first communication network. Optionally, the second device may include a second communication unit, and the sixth information may be received by the second communication unit in the second device. For example, the first device may transmit the sixth information to the second communication unit over the first communication network.

Further, the second device may transmit a reassociation response frame to the first device to establish a connection (corresponding to the second communication network) to the first device.

Optionally, the second device may further include a third communication unit. After establishment of the connection to the first device, the second communication unit may transmit tenth information to the third communication unit. Optionally, the tenth information may be used to indicate that the first device accesses (or has accessed) the second communication network. In other words, the tenth information may inform the third communication unit that the second communication unit has established the connection to the first device.

Further, the second device may transmit eleventh information to a third device. Optionally, the eleventh information may be used to indicate that the first device has accessed the second communication network. For example, the third communication unit may inform the third device through a device join network (DeviceJoinNetwork) notification that the first device has accessed the second communication network.

Optionally, the eleventh information may be carried in the DeviceJoinNetwork notification. Optionally, the eleventh information may be stored in a DeviceJoinNetwork event in the second device. For example, when a device accesses a communication network (e.g., the first device accesses the second communication network), the second device may record this event in an event list corresponding to a DeviceJoinNetwork event. A client may subscribe to the DeviceJoinNetwork event. After subscription to the DeviceJoinNetwork event, when the event list changes, the second device transmits a DeviceJoinNetwork notification to the client.

Optionally, the third device may be a managing device (in the communication network and/or fabric), such as the terminal device 120 in FIG. 1. For example, the third device may be a commissioner (commissioner). As an example, an application (APP) in a user's mobile phone or other terminal device may serve as a commissioner in the communication network (or fabric).

In some embodiments, before S210, the first device may receive seventh information.

Optionally, the seventh information may be used to configure the first device, so that the second device has administrative privileges for a fabric corresponding to the first device. Optionally, the seventh information may be transmitted by the third device. For example, the first device may receive the seventh information transmitted by the third device.

In some embodiments, before S210, the third device may transmit twelfth information.

Optionally, the twelfth information may be used to request enabling of the first communication network. Optionally, the twelfth information may be carried in a Matter network request (MatterNetworkRequest) command. Optionally, the twelfth information may be a NetworkStatus field in the MatterNetworkRequest command.

The twelfth information may be received by the second device. For example, the third device may transmit the twelfth information to the second device. Optionally, the twelfth information may be received by the third communication unit in the second device. For example, the third device may transmit the twelfth information to the third communication unit.

In some embodiments, after the third device transmits the twelfth information, the second device may transmit thirteenth information.

Optionally, the thirteenth information may be used to indicate that the first communication network has been enabled. Optionally, the thirteenth information may include an identifier of the first communication network and indication information for indicating a network status of the first communication network. Optionally, the thirteenth information may be carried in a Matter network response (MatterNetworkResponse) command. Optionally, the indication information may be a NetworkStatus field in the MatterNetworkResponse command.

The thirteenth information may be received by the third device. For example, the second device may transmit the thirteenth information to the third device. Optionally, the thirteenth information may be transmitted by the third communication unit in the second device. For example, the third communication unit may transmit the thirteenth information to the third device.

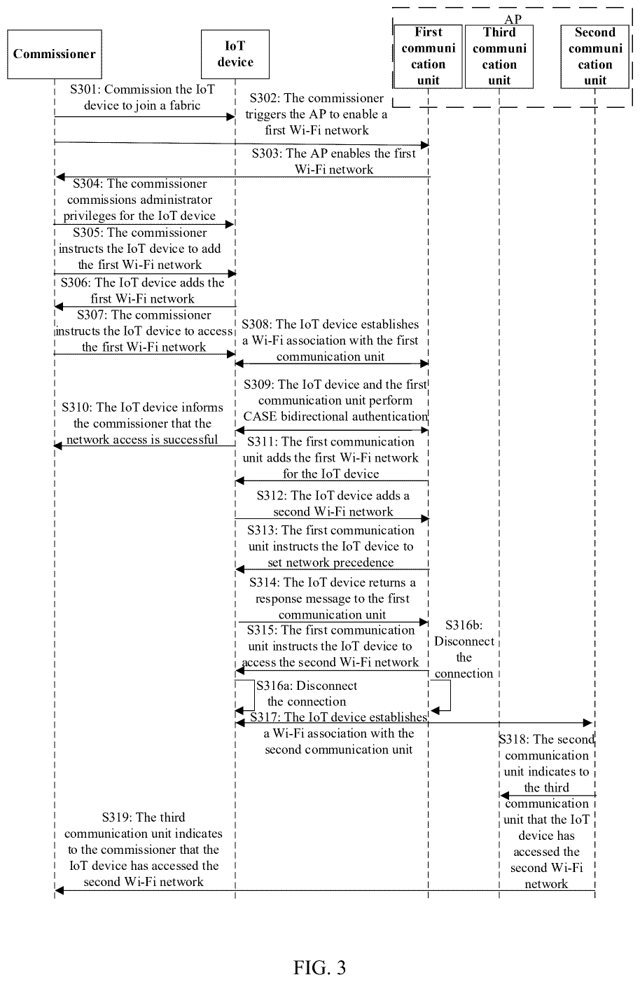

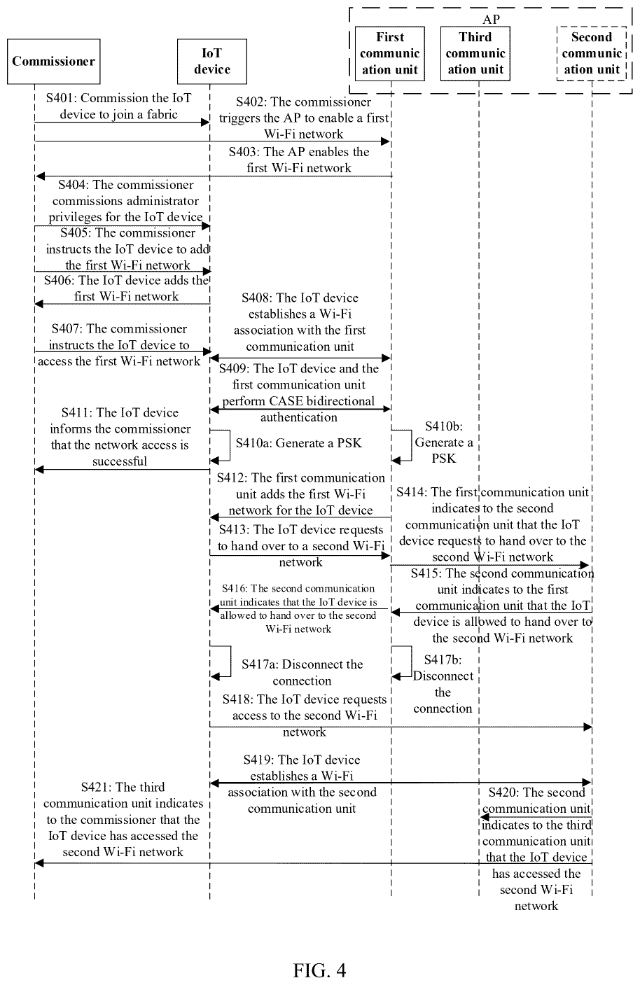

With reference to FIG. 3 and FIG. 4, the above-described solution in FIG. 2 is illustrated by using an example in which the first communication network is a Wi-Fi network and the target authentication mode indicates performing authentication by using a Matter NOC as a credential.

FIG. 3 is a schematic flowchart of a method for accessing a network according to an embodiment of this application. The method 300 shown in FIG. 3 may include steps S301 to S319. Details are as follows.

S301: A commissioner commissions an IoT device to join a fabric and issues an NOC certificate.

S302: The commissioner triggers an AP to enable a first Wi-Fi network.

The first Wi-Fi network may support Matter authentication. Supporting the Matter authentication may refer to supporting accessing a Wi-Fi network by using a Matter NOC certificate as a credential. For example, upon establishment of the connection to the first Wi-Fi network, the IoT device and a first communication unit can perform CASE bidirectional authentication based on NOC certificates (as in the subsequent step S309). After the authentication is completed, the IoT device can establish a Wi-Fi association with the first communication unit to access the first Wi-Fi network.

A Wi-Fi network that supports Matter authentication can be controlled using the following commands:

| ID | Name | Direction | Response | Access | Conformance |
|---|---|---|---|---|---|
| 0 | MatterNetworkRequest | Client ⇒ | MatterNetworkResponse | FA | M |
| | | server | | | |
| 1 | MatterNetworkResponse | Server ⇒ | N | FA | M |
| | | Client | | | |

The MatterNetworkRequest argument is used by an administrator (Administrator) to change the status of a private network and may include the following arguments:

| ID | Name | Type | Constraint | Quality | Default value | Conformance |
|---|---|---|---|---|---|---|
| 0 | NetworkStatus | NetworkStatusEnum | | | 0 | M |
| 1 | SSID | [octstr-def] | 1 to 32 | X | null | O |
| 2 | Breadcrumb | uint64 | all | | | O |

The NetworkStatusEnum type is an 8-bit enumeration (enum8) data type. A value of 0 indicates that the network is disabled, and a value of 1 indicates that the network is enabled.

After receipt of the command, the AP enables or disables the private network based on the arguments, and then returns MatterNetworkResponse, which may include the following arguments:

| ID | Name | Type | Constraint | Quality | Default | Conformance |
|---|---|---|---|---|---|---|
| 0 | NetworkStatus | NetworkStatusEnum | | | 0 | M |
| 1 | SSID | [octstr-def] | 1 to 32 | X | null | O |

When MatterNetworkRequest contains an SSID, the AP sets the SSID as an SSID of the private network, and MatterNetworkResponse may not contain the SSID. When MatterNetworkRequest does not contain an SSID, the AP automatically sets an SSID of the private network and returns the SSID of the private network to the administrator device through MatterNetworkResponse.

As shown in FIG. 3, the AP may include the first communication unit, a second communication unit, and a third communication unit. The first communication unit may establish the first Wi-Fi network, the second communication unit may establish a second Wi-Fi network, and the third communication unit may be a server of the AP.

The commissioner may transmit the MatterNetworkRequest command to the third communication unit in the AP to trigger the AP to enable the first Wi-Fi network. The MatterNetworkRequest command may specify the SSID of the Matter private network, or may not specify the SSID of the first Wi-Fi network.

S303: The AP enables the first Wi-Fi network.

The third communication unit may turn on the first communication unit, so that the first communication unit establishes the first Wi-Fi network. The third communication unit may return the status and SSID of the first Wi-Fi network to the commissioner.

S304: The commissioner commissions administrator (administer) privileges for the IoT device.

The commissioner may configure the IoT device, so that the AP has administrator privileges for a network commissioning cluster of the IoT device.

S305: The commissioner instructs the IoT device to add the first Wi-Fi network.

The commissioner may instruct the IoT device to add the first Wi-Fi network through an AddOrUpdateWiFiNetwork command. Optionally, the Credentials parameter in the AddOrUpdateWiFiNetwork command may be a node identifier (NodeID) of the AP in the current fabric. The Credentials parameter may be used for CASE bidirectional authentication between the IoT device and the first communication unit (as in the subsequent step S309). For example, when performing CASE bidirectional authentication with the first communication unit, the IoT device may transmit a Sigma1 message to the first communication unit, where the Sigma1 message may carry the NodeID of the AP.

S306: The IoT device adds the first Wi-Fi network.

After receipt of the AddOrUpdateWiFiNetwork command, the IoT device may add the first Wi-Fi network to the Networks attribute.

Further, the IoT device may return a response message to the commissioner through a NetworkConfigResponse command.

S307: The commissioner instructs the IoT device to access the first Wi-Fi network.

The commissioner may instruct the IoT device to access the first Wi-Fi network through a ConnectNetwork command.

S308: The IoT device establishes a Wi-Fi association with the first communication unit.

S309: The IoT device and the first communication unit perform certificate authenticated session establishment (CASE) bidirectional authentication.

The IoT device and the first communication unit may perform CASE bidirectional authentication based on the NOC certificates.

For example, the IoT device may transmit a Sigma1 message to the first communication unit, where the Sigma1 message may carry the NodeID of the AP; the first communication unit may transmit a Sigma2 message to the IoT device, where the Sigma2 message may carry the NOC certificate of the AP in the current fabric; and the IoT device may transmit a Sigma3 message to the first communication unit, where the Sigma3 message may carry the NOC certificate of the IoT device in the current fabric.

S310: The IoT device informs the commissioner that the network access is successful.

The IoT device transmits a ConnectNetworkResponse command to the commissioner to inform the commissioner that the first Wi-Fi network is successfully accessed.

S311: The first communication unit adds the first Wi-Fi network for the IoT device.

The first communication unit may add the first Wi-Fi network for the IoT device through the AddOrUpdateWiFiNetwork command. The SSID parameter in the AddOrUpdateWiFiNetwork command may be an SSID of the second Wi-Fi network, and the Credentials parameter may be a password for the second Wi-Fi network. The Credentials parameter may be used by the IoT device to establish a Wi-Fi association with the second communication unit (as in the subsequent step S317). For example, when establishing the Wi-Fi association with the second communication unit, the IoT device and the second communication unit may perform authentication based on the password for the second Wi-Fi network.

S312: The IoT device adds the second Wi-Fi network.

After receipt of the AddOrUpdateWiFiNetwork command, the IoT device may add the second Wi-Fi network to the Networks attribute.

Further, the IoT device may return a response message to the first communication unit through a NetworkConfigResponse command.

S313: The first communication unit instructs the IoT device to set network precedence.

The first communication unit may instruct the IoT device to set the second Wi-Fi network as a first precedence network and set the first Wi-Fi network as a second precedence network through the ReorderNetwork command.

S314: The IoT device returns the response message to the first communication unit.

The IoT device returns the response message to the first communication unit through the NetworkConfigResponse command.

S315: The first communication unit instructs the IoT device to access the second Wi-Fi network.

The first communication unit may instruct the IoT device to access the second Wi-Fi network through a ConnectNetwork command.

S316: The IoT device disconnects from the first communication unit.

S317: The IoT device establishes a Wi-Fi association with the second communication unit.

The IoT device establishes the Wi-Fi association with and establishes a Wi-Fi connection to the second communication unit.

S318: The second communication unit indicates to the third communication unit that the IoT device has accessed the second Wi-Fi network.

S319: The third communication unit indicates to the commissioner that the IoT device has accessed the second Wi-Fi network.

After the IoT device accesses the second Wi-Fi network, the AP may transmit a DeviceJoinNetwork notification. The DeviceJoinNetwork notification may be as follows:

| ID | Name | Priority | Access | Conformance |
|---|---|---|---|---|
| 0 | DeviceJoinNetwork | INFO | FV | M |

Priority being INFO indicates that an event priority is a general notification for the client. The DeviceJoinNetwork event may be stored in the AP. The DeviceJoinNetwork event may include the following data:

| ID | Name | Type | Constraint | Conformance |
|---|---|---|---|---|
| 0 | DeviceID | node-id | all | M |
| 1 | SSID | [octstr-def] | 1 to 32 | M |

The third communication unit may inform the commissioner through a DeviceJoinNetwork notification that the IoT device has accessed the second Wi-Fi network.

If the IoT device's network connection is disconnected, the network connection may be restored by using the following method:

The IoT device may rescan for Wi-Fi networks and connects to the second Wi-Fi network with a priority. When the IoT device fails to connect to the second Wi-Fi network, the IoT device may choose to connect to the first Wi-Fi network. In this case, the IoT device repeats S308 and S309 above to connect to the first Wi-Fi network. Upon connecting to the first Wi-Fi network, the IoT device repeats S310 to S317 above to reconnect to the second Wi-Fi network.

FIG. 4 is a schematic flowchart of a method for accessing a network according to an embodiment of this application. The method 400 shown in FIG. 4 may include steps S401 to S421. Details are as follows.

S401: A commissioner commissions an IoT device to join a fabric and issues an NOC certificate.

S402: The commissioner triggers an AP to enable a first Wi-Fi network.

The first Wi-Fi network may support Matter authentication. Supporting the Matter authentication may indicate supporting accessing a Wi-Fi network by using a Matter NOC certificate as a credential. For example, upon establishment of the connection to the first Wi-Fi network, the IoT device and a first communication unit can perform CASE bidirectional authentication based on NOC certificates (as in the subsequent step S409). After the authentication is completed, the IoT device can establish a Wi-Fi association with the first communication unit to access the first Wi-Fi network.

A Wi-Fi network that supports Matter authentication can be controlled using the following commands:

| ID | Name | Direction | Response | Access | Conformance |
|---|---|---|---|---|---|
| 0 | MatterNetworkRequest | Client ⇒ | MatterNetworkResponse | FA | M |
| | | server | | | |
| 1 | MatterNetworkResponse | Server ⇒ | N | FA | M |
| | | Client | | | |

The argument MatterNetworkRequest is used by an administrator (Administrator) to change the status of a private network and may include the following arguments:

| ID | Name | Type | Constraint | Quality | Default value | Conformance |
|---|---|---|---|---|---|---|
| 0 | NetworkStatus | NetworkStatusEnum | | | 0 | M |
| 1 | SSID | [octstr-def] | 1 to 32 | X | null | O |
| 2 | Breadcrumb | uint64 | all | | | O |

The NetworkStatusEnum type is an 8-bit enumeration (enum8) data type. A value of 0 indicates that the network is disabled, and a value of 1 indicates that the network is enabled.

After receipt of the command, the AP enables or disables the private network based on the arguments, and then returns MatterNetworkResponse, which may include the following arguments:

| ID | Name | Type | Constraint | Quality | Default | Conformance |
|---|---|---|---|---|---|---|
| 0 | NetworkStatus | NetworkStatusEnum | | | 0 | M |
| 1 | SSID | [octstr-def] | 1 to 32 | X | null | O |

When MatterNetworkRequest contains an SSID, the AP sets the SSID as an SSID of the private network, and MatterNetworkResponse may not contain the SSID. When MatterNetworkRequest does not contain an SSID, the AP automatically sets an SSID of the private network and returns the SSID of the private network to the administrator device through MatterNetworkResponse.

As shown in FIG. 4, the AP may include the first communication unit, a second communication unit, and a third communication unit. The first communication unit may establish the first Wi-Fi network, the second communication unit may establish a second Wi-Fi network, and the third communication unit may be a server of the AP.

The commissioner may transmit the MatterNetworkRequest command to the third communication unit in the AP to trigger the AP to enable the first Wi-Fi network. The MatterNetworkRequest command may specify the SSID of the Matter private network, or may not specify the SSID of the first Wi-Fi network.

S403: The AP enables the first Wi-Fi network.

The third communication unit may turn on the first communication unit, so that the first communication unit establishes the first Wi-Fi network. The third communication unit may return the status and SSID of the first Wi-Fi network to the commissioner.

S404: The commissioner commissions administrator (administer) privileges for the IoT device.

The commissioner may configure the IoT device, so that the AP has administrator privileges for a network commissioning cluster of the IoT device.

S405: The commissioner instructs the IoT device to add the first Wi-Fi network.

The commissioner may instruct the IoT device to add the first Wi-Fi network through an AddOrUpdateWiFiNetwork command. Optionally, the Credentials parameter in the AddOrUpdateWiFiNetwork command may be a node identifier (NodeID) of the AP in the current fabric. The Credentials parameter may be used for CASE bidirectional authentication between the IoT device and the first communication unit (as in the subsequent step S409). For example, when performing CASE bidirectional authentication with the first communication unit, the IoT device may transmit a Sigma1 message to the first communication unit, where the Sigma1 message may carry the NodeID of the AP.

S406: The IoT device adds the first Wi-Fi network.

After receipt of the AddOrUpdate WiFiNetwork command, the IoT device may add the first Wi-Fi network to the Networks attribute.

Further, the IoT device may return a response message to the commissioner through a NetworkConfigResponse command.

S407: The commissioner instructs the IoT device to access the first Wi-Fi network.

The commissioner may instruct the IoT device to access the first Wi-Fi network through a ConnectNetwork command.

S408: The IoT device establishes a Wi-Fi association with the first communication unit.

S409: The IoT device and the first communication unit perform certificate authenticated session establishment (CASE) bidirectional authentication.

The IoT device and the first communication unit may perform CASE bidirectional authentication based on the NOC certificates.

For example, the IoT device may transmit a Sigma1 message to the first communication unit, where the Sigma1 message may carry the NodeID of the AP; the first communication unit may transmit a Sigma2 message to the IoT device, where the Sigma2 message may carry the NOC certificate of the AP in the current fabric; and the IoT device may transmit a Sigma3 message to the first communication unit, where the Sigma3 message may carry the NOC certificate of the IoT device in the current fabric.

S410: The IoT device and the first communication unit negotiate a shared key (such as a PSK shown in FIG. 4).

The IoT device and the first communication unit may negotiate a pairwise master key (pairwise master key, PMK).

S411: The IoT device informs the commissioner that the network access is successful.

The IoT device transmits a ConnectNetworkResponse command to the commissioner to inform the commissioner that the first Wi-Fi network is successfully accessed.

S412: The first communication unit adds the first Wi-Fi network for the IoT device.

The first communication unit may add the first Wi-Fi network for the IoT device through the AddOrUpdateWiFiNetwork command. The SSID parameter in the AddOrUpdate WiFiNetwork command may be an SSID of the second Wi-Fi network, and the Credentials parameter may be the PMK. The Credentials parameter may be used by the IoT device to request access to the second Wi-Fi network from the second communication unit (as in the subsequent step S418). For example, the IoT device transmits a reassociation request frame to the second communication unit to request access to the second Wi-Fi network. The reassociation request frame may carry an identifier (ID) of the PMK.

After receipt of the AddOrUpdateWiFiNetwork command, the IoT device may add the second Wi-Fi network to the Networks attribute.

S413: The IoT device requests to hand over to the second Wi-Fi network.

The IoT device may transmit an FT request frame to the first communication unit to request to hand over to the second Wi-Fi network. The FT request frame may carry the SSID of the second Wi-Fi network, the identifier (ID) of the PMK, and a nonce SNonce generated by the IoT device.

S414: The first communication unit indicates to the second communication unit that the IoT device requests to hand over to the second Wi-Fi network.

The first communication unit may transmit the SNonce, the PMK ID, and the PMK to the second communication unit.

S415: The second communication unit indicates to the first communication unit that the IoT device is allowed to hand over to the second Wi-Fi network.

The second communication unit may transmit the SNonce and a nonce ANonce generated by the second communication unit to the first communication unit.

S416: The second communication unit indicates to the IoT device that the IoT device is allowed to hand over to the second Wi-Fi network.

The second communication unit may return the SSID of the second Wi-Fi network, PMK ID, SNonce, and ANonce to the IoT device through an FT response frame.

S417: The IoT device disconnects from the first communication unit.

S418: The IoT device requests access to the second Wi-Fi network.

The IoT device transmits a reassociation request frame to the second communication unit for a Wi-Fi association. The reassociation request frame may carry the PMK ID, SNonce, and ANonce.

S419: The IoT device establishes a Wi-Fi association with the second communication unit.

The second communication unit may return a reassociation response frame to the IoT device to establish a Wi-Fi connection.

S420: The second communication unit indicates to the third communication unit that the IoT device has accessed the second Wi-Fi network.

S421: The third communication unit indicates to the commissioner that the IoT device has accessed the second Wi-Fi network.

After the IoT device accesses the second Wi-Fi network, the AP may transmit a DeviceJoinNetwork notification. The DeviceJoinNetwork notification may be as follows:

| ID | Name | Priority | Access | Conformance |
|---|---|---|---|---|
| 0 | DeviceJoinNetwork | INFO | V | M |

Priority being INFO indicates that the event priority is a general notification for the client. The DeviceJoinNetwork event may be stored in the AP. The DeviceJoinNetwork event may include the following data:

| ID | Name | Type | Constraint | Conformance |
|---|---|---|---|---|
| 0 | DeviceID | node-id | all | M |
| 1 | SSID | [octstr-def] | 1 to 32 | M |

The third communication unit may inform the commissioner through a DeviceJoinNetwork notification that the IoT device has accessed the second Wi-Fi network.

If the IoT device's network connection is disconnected, the network connection may be restored by using the following method:

The IoT device may rescan Wi-Fi networks and connects to the second Wi-Fi network with a priority. When the IoT device fails to connect to the second Wi-Fi network, the IoT device may choose to connect to the first Wi-Fi network. In this case, the IoT device repeats S408 and S410 above to connect to the first Wi-Fi network. Upon connecting to the first Wi-Fi network, the IoT device repeats S412 to S421 above to reconnect to the second Wi-Fi network.

The method embodiments of this application are described in detail above with reference to FIG. 1 to FIG. 4. Apparatus embodiments of this application are described in detail below with reference to FIG. 5 to FIG. 8. It should be understood that the description of the method embodiments corresponds to the description of the apparatus embodiments, and therefore, for parts that are not described in detail, one may refer to the foregoing method embodiments.

FIG. 5 is a schematic structural diagram of an apparatus for accessing a network according to an embodiment of this application. As shown in FIG. 5, the apparatus 500 includes a receiving unit 510. Details are as follows.

The receiving unit 510 is configured to receive first information over a first communication network, where the first information is used to indicate a second communication network to the apparatus, and the first communication network supports a target authentication mode.

Optionally, the first information includes an identifier of the second communication network.

Optionally, the first information further includes a password or a shared key of the second communication network.

Optionally, the first information is carried in an AddOrUpdateWiFiNetwork command.

Optionally, after receipt of the first information over the first communication network, the receiving unit 510 is further configured to receive second information over the first communication network, where the second information is used to instruct the apparatus to join the second communication network.

Optionally, the second information is carried in a ConnectNetwork command.

Optionally, the receiving unit 510 is further configured to receive third information over the first communication network, where the third information is used to instruct the apparatus to adjust precedence of the second communication network.

Optionally, the third information is carried in a ReorderNetwork command.

Optionally, the apparatus 500 further includes a transmitting unit 520 configured to transmit, after the first information is received over the first communication network, fourth information over the first communication network. The fourth information is used to request to hand over to the second communication network.

Optionally, the fourth information includes an identifier of the second communication network, an identifier of a shared key, and a first nonce.

Optionally, the fourth information is carried in an FT request frame.

Optionally, after the fourth information is transmitted over the first communication network, the receiving unit 510 is further configured to receive fifth information over the first communication network, where the fifth information is used to respond to the fourth information.

Optionally, the fifth information is used to indicate allowing the apparatus to hand over to the second communication network.

Optionally, the fifth information includes an identifier of the second communication network, an identifier of a shared key, a first nonce, and/or a second nonce.

Optionally, the fifth information is carried in an FT response frame.

Optionally, the apparatus further includes a transmitting unit 520 configured to transit, after the fifth information is received over the first communication network, sixth information, where the sixth information is used to request to hand over to the second communication network.

Optionally, the sixth information includes an identifier of a shared key, a first nonce, and a second nonce.

Optionally, the sixth information is carried in a reassociation request frame.

Optionally, before receipt of the first information over the first communication network, the receiving unit 510 is further configured to receive seventh information, where the seventh information is used to configure the apparatus, so that a second device has administrative privileges for a fabric corresponding to the apparatus.

Optionally, the target authentication mode indicates performing authentication by using a node operational certificate NOC in the fabric.

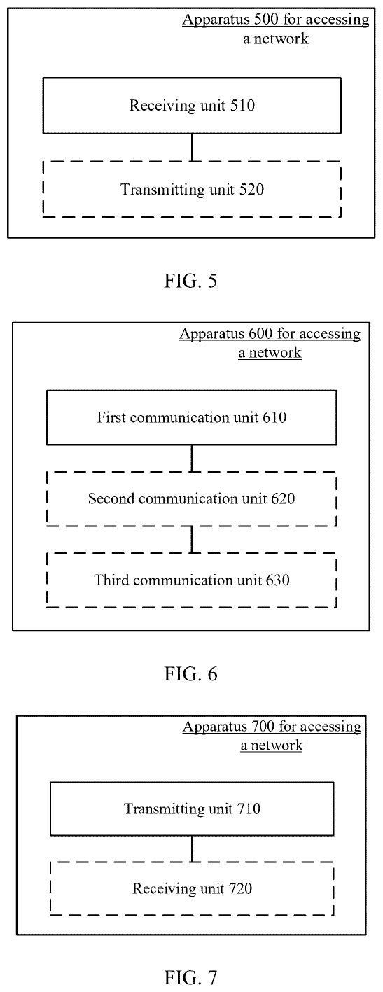

FIG. 6 is a schematic structural diagram of an apparatus for accessing a network according to an embodiment of this application. The apparatus 600 for accessing a network in FIG. 6 includes a first communication unit 610. Details are as follows.

The first communication unit 610 is configured to transmit first information over a first communication network, where the first information is used to indicate a second communication network to a first device, and the first communication network supports a target authentication mode.

Optionally, the first information includes an identifier of the second communication network.

Optionally, the first information further includes a password or a shared key of the second communication network.

Optionally, the first information is carried in an AddOrUpdateWiFiNetwork command.

Optionally, after transmission of the first information over the first communication network, the first communication unit 610 is configured to transmit second information over the first communication network, where the second information is used to instruct the first device to join the second communication network.

Optionally, the second information is carried in a ConnectNetwork command.

Optionally, the first communication unit 610 is further configured to transmit third information over the first communication network, where the third information is used to instruct the first device to adjust precedence of the second communication network.

Optionally, the third information is carried in a ReorderNetwork command.

Optionally, after transmission of the first information over the first communication network, the first communication unit 610 is further configured to receive fourth information over the first communication network, where the fourth information is used to request to hand over to the second communication network.

Optionally, the fourth information includes an identifier of the second communication network, an identifier of a shared key, and a first nonce.

Optionally, the fourth information is carried in an FT request frame.

Optionally, the apparatus 600 further includes a second communication unit 620 configured to receive, after receipt of the fourth information over the first communication network, eighth information transmitted by the first communication unit, where the eighth information is used to indicate that the first device requests to hand over to the second communication network.

Optionally, the eighth information includes a shared key, an identifier of the shared key, and a first nonce.

Optionally, after receipt of the eighth information transmitted by the first communication unit, the second communication unit 620 is further configured to transmit ninth information to the first communication unit, where the ninth information is used to indicate allowing the first device to hand over to the second communication network.

Optionally, the ninth information includes a first nonce and a second nonce.

Optionally, after receipt of the fourth information over the first communication network, the first communication unit 610 is further configured to transmit fifth information over the first communication network, where the fifth information is used to respond to the fourth information.

Optionally, the fifth information is used to indicate allowing the first device to hand over to the second communication network.

Optionally, the fifth information includes an identifier of the second communication network, an identifier of a shared key, a first nonce, and/or a second nonce.

Optionally, the fifth information is carried in an FT response frame.

Optionally, after transmission of the fifth information over the first communication network, the second communication unit 620 is further configured to receive sixth information, where the sixth information is used to request a connection to the second communication network.

Optionally, the sixth information includes an identifier of a shared key, a first nonce, and a second nonce.

Optionally, the sixth information is carried in a reassociation request frame.

Optionally, the apparatus 600 further includes a third communication unit 630 configured to receive, after the first communication unit transmits the first information over the first communication network, tenth information transmitted by the second communication unit, where the tenth information is used to indicate that the first device accesses the second communication network.

Optionally, after receipt of the tenth information transmitted by the second communication unit, the third communication unit is further configured to transmit eleventh information, where the eleventh information is used to indicate that the first device accesses the second communication network.

Optionally, the eleventh information is carried in a DeviceJoinNetwork notification.

Optionally, the eleventh information is stored in a DeviceJoinNetwork event in the second device.

Optionally, the apparatus 600 further includes a third communication unit 630 configured to receive, before transmission of the first information over the first communication network, twelfth information, where the twelfth information is used to request enabling of the first communication network.

Optionally, the twelfth information is carried in a MatterNetworkRequest command.

Optionally, the twelfth information is a NetworkStatus field in the MatterNetworkRequest command.

Optionally, after receipt of the twelfth information, the third communication unit 630 is further configured to transmit thirteenth information, where the thirteenth information is used to indicate that the first communication network has been enabled.

Optionally, the thirteenth information includes an identifier of the first communication network and indication information for indicating a network status of the first communication network.

Optionally, the thirteenth information is carried in a MatterNetworkResponse command.

Optionally, the indication information is a NetworkStatus field in the MatterNetworkResponse command.

Optionally, the target authentication mode indicates performing authentication by using a node operational certificate NOC in the fabric.

FIG. 7 is a schematic structural diagram of an apparatus for accessing a network according to an embodiment of this application. The apparatus 700 for accessing a network in FIG. 7 includes a transmitting unit 710. Details are as follows.

The transmitting unit 710 is configured to transmit twelfth information, where the twelfth information is used to request enabling of the first communication network.

Optionally, the twelfth information is carried in a MatterNetworkRequest command.

Optionally, the twelfth information is a NetworkStatus field in the MatterNetworkRequest command.

Optionally, the apparatus 700 further includes a receiving unit 720 configured to receive, after the twelfth information is transmitted, thirteenth information, where the thirteenth information is used to indicate that the first communication network has been enabled.

Optionally, the thirteenth information includes an identifier of the first communication network and indication information for indicating a network status of the first communication network.

Optionally, the thirteenth information is carried in a MatterNetworkResponse command.

Optionally, the indication information is a NetworkStatus field in the MatterNetworkResponse command.

Optionally, after the thirteenth information is received, the transmitting unit 710 is further configured to transmit seventh information, where the seventh information is used to configure a first device, so that a second device has administrative privileges for a fabric corresponding to the first device.

Optionally, the apparatus 700 further includes a receiving unit 720 configured to receive, after the twelfth information is transmitted, eleventh information, where the eleventh information is used to indicate that the first device accesses the second communication network.

Optionally, the eleventh information is carried in a DeviceJoinNetwork notification.

Optionally, the eleventh information is stored in a DeviceJoinNetwork event in the second device.

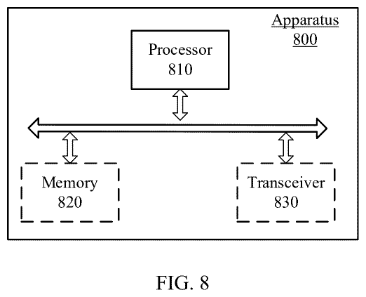

FIG. 8 is a schematic structural diagram of an apparatus according to an embodiment of this application. Dashed lines in FIG. 8 indicate that a unit or module is optional. The apparatus 800 may be configured to implement the methods described in the foregoing method embodiments. The apparatus 800 may be a chip or an apparatus for accessing a network.

The apparatus 800 may include one or more processors 810. The processor 810 may support the apparatus 800 in implementing the methods described in the foregoing method embodiments. The processor 810 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 800 may further include one or more memories 820. The memory 820 stores a program, where the program may be executed by the processor 810, to cause the processor 810 to perform the methods described in the foregoing method embodiments. The memory 820 may be separate from the processor 810 or may be integrated into the processor 810.

The apparatus 800 may further include a transceiver 830. The processor 810 may communicate with another device or chip through the transceiver 830. For example, the processor 810 may transmit data to and receive data from another device or chip by using the transceiver 830.

An embodiment of this application further provides a computer-readable storage medium for storing a program. The computer-readable storage medium may be used in the apparatus for accessing a network according to embodiments of this application, and the program causes a computer to perform the method performed by the apparatus for accessing a network in various embodiments of this application.

An embodiment of this application further provides a computer program product. The computer program product includes a program. The computer program product may be used in the apparatus for accessing a network according to embodiments of this application, and the program causes a computer to perform the method performed by the apparatus for accessing a network in various embodiments of this application.

An embodiment of this application further provides a computer program. The computer program may be used in the apparatus for accessing a network according to embodiments of this application, and the computer program causes a computer to perform the method performed by the apparatus for accessing a network in various embodiments of this application.

It should be understood that, in embodiments of this application, “B that is corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes, and should not be construed as any limitation on the implementation processes of the embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the mutual coupling or direct coupling or communication connection shown or discussed may be indirect coupling or communication connection through some interfaces, apparatuses, or units, and may be in electrical, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the scope of protection of this application is not limited thereto. Any variation or replacement readily figured out by a person skilled in the art within the technical scope disclosed in this application shall fall within the scope of protection of this application. Therefore, the scope of protection of this application shall be subject to the scope of protection of the claims.

What is claimed is:

1. A method for accessing a network, comprising:
receiving, by a first device, first information over a first communication network, wherein the first information is used to indicate a second communication network to the first device, and the first communication network supports a target authentication mode.

2. The method according to claim 1, wherein the first information comprises an identifier of the second communication network.

3. The method according to claim 2, wherein the first information further comprises a password or a shared key of the second communication network.

4. The method according to claim 1, wherein after the receiving, by the first device, the first information over the first communication network, the method further comprises:
receiving, by the first device, second information over the first communication network, wherein the second information is used to instruct the first device to join the second communication network.

5. The method according to claim 4, wherein the second information is carried in a ConnectNetwork command.

6. The method according to claim 4, wherein the method further comprises:
receiving, by the first device, third information over the first communication network, wherein the third information is used to instruct the first device to adjust precedence of the second communication network.

7. The method according to claim 1, wherein after the receiving, by the first device, the first information over the first communication network, the method further comprises:
transmitting, by the first device, fourth information over the first communication network, wherein the fourth information is used to request to hand over to the second communication network.

8. The method according to claim 7, wherein the fourth information comprises an identifier of the second communication network, an identifier of a shared key, and a first nonce.

9. The method according to claim 7, wherein after the transmitting, by the first device, the fourth information over the first communication network, the method further comprises:
receiving, by the first device, fifth information over the first communication network, wherein the fifth information is used to respond to the fourth information.

10. The method according to claim 9, wherein the fifth information is used to indicate allowing the first device to hand over to the second communication network.

11. The method according to claim 9, wherein after the receiving, by the first device, the fifth information over the first communication network, the method further comprises:
transmitting, by the first device, sixth information, wherein the sixth information is used to request a connection to the second communication network.

12. The method according to claim 1, wherein before the receiving, by the first device, the first information over the first communication network, the method further comprises:
receiving, by the first device, seventh information, wherein the seventh information is used to configure the first device, so that a second device has administrative privileges for a fabric corresponding to the first device.

13. An apparatus for accessing a network, comprising a memory and a processor, wherein the memory is configured to store a computer program, and the processor is configured to execute the computer program stored in the memory to cause the apparatus to perform an operation of:
transmitting first information over a first communication network, wherein the first information is used to indicate a second communication network to a first device, and the first communication network supports a target authentication mode.

14. The apparatus according to claim 13, wherein after the transmitting the first information over the first communication network, the apparatus is further configured to:
transmit second information over the first communication network, wherein the second information is used to instruct the first device to join the second communication network.

15. The apparatus according to claim 13, wherein after the transmitting the first information over the first communication network, the apparatus is further configured to:
receive fourth information over the first communication network, wherein the fourth information is used to request to hand over to the second communication network.

16. The apparatus according to claim 15, wherein after the receiving the fourth information over the first communication network, the apparatus is further configured to:
receive eighth information transmitted by the first communication unit, wherein the eighth information is used to indicate that the first device requests to hand over to the second communication network.

17. The apparatus according to claim 15, wherein after the receiving the fourth information over the first communication network, the apparatus is further configured to:
transmit fifth information over the first communication network, wherein the fifth information is used to respond to the fourth information.

18. An apparatus for accessing a network, comprising a memory and a processor, wherein the memory is configured to store a computer program, and the processor is configured to execute the computer program stored in the memory to cause the apparatus to perform an operation of:
transmit twelfth information, wherein the twelfth information is used to request enabling of a first communication network.

19. The apparatus according to claim 18, wherein after the transmitting the twelfth information, the apparatus is further configured to:
receive eleventh information, wherein the eleventh information is used to indicate that the first device accesses the second communication network.

20. An apparatus for accessing a network, comprising a memory and a processor, wherein the memory is configured to store a computer program, and the processor is configured to execute the computer program stored in the memory to cause the apparatus to perform the method according to claim 1.
